(19) United States
(12) Patent Application Publication
(10) Pub. No.: US 2024/0081548 A1
(43) Pub. Date: Mar. 14, 2024

(54) BED FOUNDATION AND METHODS FOR ASSEMBLING THE SAME

(71) Applicant: Sealy Technology, LLC, Trinity, NC (US)

(72) Inventors: Robert Hanson, III, Greensboro, NC (US); Brian M. Manuszak, Thomasville, NC (US)

(21) Appl. No.: 18/244,110

(22) Filed: Sep. 8, 2023

Related U.S. Application Data
(60) Provisional application No. 63/405,029, filed on Sep. 9, 2022.

(51) Int. Cl. A47C 19/02; A47C 19/00

(52) U.S. Cl. CPC A47C 19/025; A47C 19/005

(57) ABSTRACT

A bed foundation includes a frame and one or more panels positioned on top of the frame to define an upper surface of the bed foundation for supporting a mattress. The frame includes a plurality of rails which, when assembled together, at least partially define the frame. The plurality of rails are comprised of a thermoplastic foam that is lighter than wood or other similarly- or heavier-weighted materials commonly utilized in the construction of bed foundations, thereby facilitating easier shipping, lifting, carrying, and assembly of the bed foundation. The one or more panels can also be comprised of thermoplastic foam. The frame can further include a plurality of brackets to interconnect select rails of the frame. A kit for a bed foundation and a method of assembling a bed foundation are also provided.

### RELATED APPLICATIONS

This application claims priority to U.S. Provisional Application Ser. No. 63/405,029, filed Sep. 9, 2022, the entire disclosure of which is incorporated herein by this reference.

### TECHNICAL FIELD

The present invention relates to bed foundations, kits for a bed foundation, and methods for assembling a bed foundation. In particular, the present invention includes bed foundations that make use of thermoplastic components which are lighter than wood and which can be press fit together to form the foundation.

### BACKGROUND

Bed assemblies generally comprise a mattress and a foundation on which the mattress rests. In recent years, online mattress sales and the utilization of third-party parcel delivery companies to deliver mattresses to consumers have become increasingly popular. To facilitate delivery by third-party delivery companies and to make it easier for the consumer to lift and carry, it is now common for mattresses to be placed in a rolled configuration and boxed. Such packaging arrangement also serves to reduce the spatial footprint of mattresses during shipping, and, in this way, can serve to reduce shipping costs. The various components of bed foundations, on the other hand, typically must exhibit some form of rigidity in order to properly support a mattress, and thus cannot be placed in a rolled configuration to reduce its spatial footprint. As such, the extent to which a bed foundation can be easily shipped, with respect to both transit logistics and cost, and subsequently lifted and carried by a consumer correlates primarily to the weight of the bed foundation. However, because the structural integrity of the bed foundation must be sufficient to support a mattress, the primary components of bed foundations have traditionally been constructed of wood or other weighted materials. As a result, bed foundations have generally remained less amendable for delivery by third-party delivery companies and difficult for consumers to lift and carry, and to then assemble using conventional fasteners (e.g., screws, nails, nuts and bolts). Furthermore, because many traditional bed foundations require the use of conventional fasteners in order to hold the respective components of the foundation together, consumers are thus required to possess certain tools in order to assemble the bed foundation once delivered.

Accordingly, a bed foundation with features that render the bed foundation more suitable for shipment by third-party delivery companies, and which facilitate easier lifting, carrying, and assembly of the bed foundation by consumers would be both highly desirable and beneficial.

### SUMMARY

The present invention includes bed foundations with components comprised of materials that are lighter than wood or other similarly- or heavier-weighted materials commonly utilized in the construction of bed foundations. In particular, the present invention includes bed foundations which make use of a frame comprised of thermoplastic foam. The reduction in weight resulting from the use of thermoplastic materials renders the bend foundations of the present invention more suitable for shipment by third-party delivery companies and facilitates easier lifting, carrying, and assembly than bed foundations comprised primarily of wood or other similarly- or heavier-weighted materials.

In one exemplary embodiment of the present invention, a bed foundation includes a frame and one or more panels positioned on top of the frame to define an upper surface of the foundation for supporting a mattress. The frame includes a plurality of rails comprised of thermoplastic foam, which, when assembled together, at least partially define the frame.

In some embodiments, the plurality of rails of the frame includes a first set of rails and a second set of rails that are interlocked with the first set of rails. The first set of rails at least partially define a perimeter of the frame, and the second set of rails define an interior structure within the perimeter of the frame that is formed by interlocking each rail of the second set of rails with at least one other rail of the second set of rails. To facilitate interlocking of the second set of rails, each rail of the second set of rails may include a notch for receiving another rail of the second set of rails. In some embodiments, the first set of rails and the second set of rails are interlocked by mortise and tenon type joints. In this regard, and in some embodiments, each end of each rail of the second set of rails defines a tenon and each rail of the first set of rails defines one or more openings in which one of the tenons defined by the second set of rails is received.

In some embodiments, the foundation further includes a plurality of brackets. Each bracket is configured to interconnect two rails from the first set of rails. In some embodiments, each bracket of the plurality of brackets is comprised of a thermoplastic material to further minimize the weight of the frame attributable to the brackets. In some embodiments, each bracket defines a first slot in which one rail of the first set of rails is received and a second slot in which another rail of the first set of rails is received. In one such embodiment, each bracket includes a first pair of flanges which define the first slot of the bracket, a second pair of flanges which define the second slot of the bracket, and a central body from which the first pair of flanges and the second pair of flanges extend. In some embodiments, the central body of each bracket is substantially hollow to further reduce the weight of the frame attributable to the brackets.

In some embodiments, the bed foundation includes multiple panels to reduce the spatial dimensions required to ship or otherwise transport the bed foundation when in a disassembled configuration. In some embodiments, each panel is removably secured to the frame of the foundation using a plurality of fasteners, such as press fasteners constructed of recyclable material, to prevent the panels from disassociating from, or moving relative to, the frame during transport or while in use while still facilitating ready disassembly and subsequent reassembly. In some embodiments, each panel of the foundation is comprised of thermoplastic foam. Suitable thermoplastic foams from which the rails of the frame and the panels can be constructed include polypropylene (PP) foam, polyethylene (PE) foam, polyethylene terephthalate (PET) foam, polyisocyanurate (polyiso) foam, polyvinyl chloride (PVC) foam, and fiberglass-reinforced polyurethane (PU) foam.

The bed foundations of the present invention can be provided to consumers in a disassembled state. The present invention thus further includes kits for a bed foundation which include some or all of the components of the various bed foundation embodiments disclosed herein.

The present invention further includes methods for assembling a bed foundation. In one exemplary implementation, a method for assembling a bed foundation includes: interlocking a plurality of rails comprised of thermoplastic foam to at least partially define a frame of the bed foundation; and positioning one or more panels on top of the frame to define an upper surface of the bed foundation for supporting a mattress.

### BRIEF DESCRIPTION OF THE DRAWINGS

FIG. 1 is a perspective view of an exemplary bed foundation made in accordance with the present invention;

FIG. 2 is a perspective view of a frame of the exemplary bed foundation of FIG. 1, but with the panels shown in FIG. 1 removed from the foundation;

FIG. 3 is an exploded view of an interior structure of the frame of the exemplary bed foundation of FIG. 1;

FIG. 4 is a top view of a bracket of the frame of the exemplary bed foundation of FIG. 1; and

FIG. 5 is a side view of a press fastener which may be used in the exemplary bed foundation of FIG. 1.

### DESCRIPTION OF EXEMPLARY EMBODIMENTS

The present invention includes bed foundations with components comprised of materials that are lighter than wood or other similarly- or heavier-weighted materials commonly utilized in the construction of bed foundations. In particular, the present invention includes bed foundations that make use of a frame comprised of thermoplastic foam and that includes components that can be press fit together. The reduction in weight resulting from the use of thermoplastic materials renders the bed foundations of the present invention more suitable for shipment by third-party delivery companies and facilitates easier lifting, carrying, and assembly as compared to bed foundations comprised primarily of wood or other similarly- or heavier-weighted materials.

Where reference is made to components of the foundation being “press fit” together, it is understood that such reference indicates that the components are typically interlocked with each other without the use of tools or fasteners. The terms “comprised of” and “constructed of” are used interchangeably throughout the present disclosure. Accordingly, unless otherwise specified, the term “constructed of”, like the term “comprised of”, is open-ended and does not exclude the presence of components or materials not expressly recited.

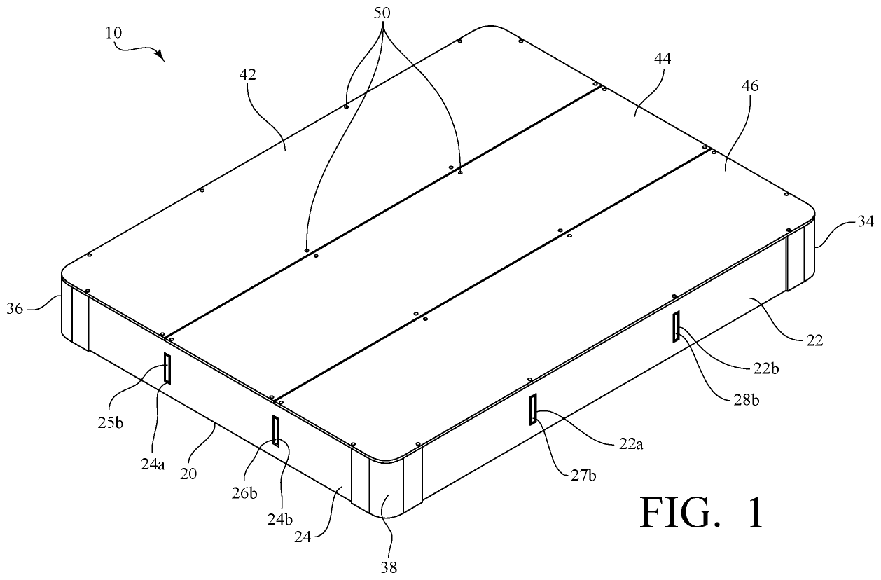

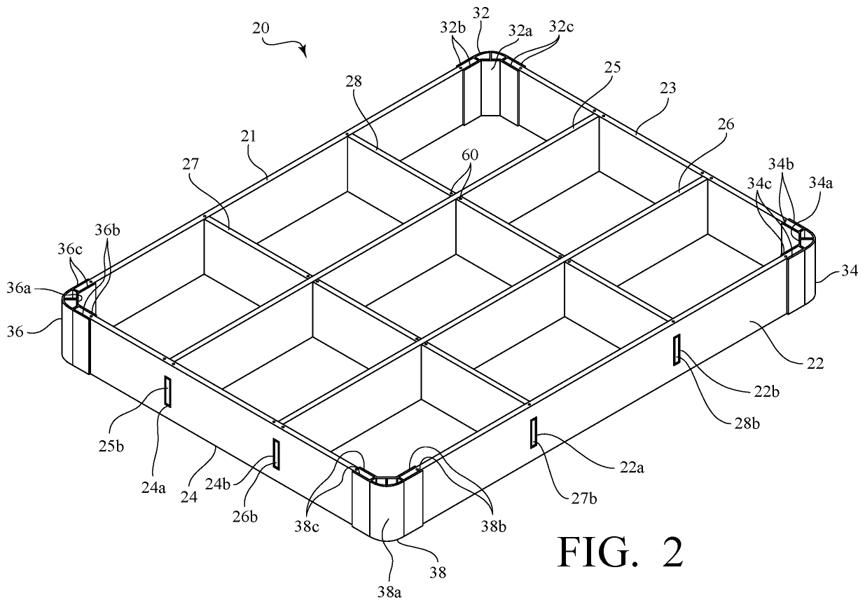

Referring first to FIGS. 1 and 2, a bed foundation (or foundation) 10 made in accordance with the present invention includes a frame 20 and one or more panels 42, 44, 46, which can be positioned on top of the frame 20 to define an upper surface of the foundation 10 for supporting a mattress (not shown). As shown in FIG. 2, the primary structure of the frame 20 is defined by, and thus can be characterized as including, a plurality of rails 21, 22, 23, 24, 25, 26, 27, 28, which can also be characterized as “slats.” Advantageously, in this exemplary embodiment, both the plurality of rails 21, 22, 23, 24, 25, 26, 27, 28 and the one or more panels 42, 44, 46 are comprised of a thermoplastic foam, which is lighter than wood, metal, or other weighted materials traditionally utilized in the construction of bed foundations.

Referring now to FIGS. 1-3, the plurality of rails 21, 22, 23, 24, 25, 26, 27, 28 defining the primary structure of the frame 20 can be characterized as including two separate sets of rails, namely a first set of rails 21, 22, 23, 24 and a second set of rails 25, 26, 27, 28. In this exemplary embodiment, the frame 20 includes a total of eight rails, of which four correspond to the first set of rails 21, 22, 23, 24 and four correspond to the second set of rails 25, 26, 27, 28. Specifically, the first set of rails 21, 22, 23, 24 includes a first pair of opposing, vertically-oriented rails 21, 22 and a first pair of opposing, horizontally-oriented rails 23, 24, which collectively define the outer perimeter of the frame 20. Likewise, the second set of rails 25, 26, 27, 28 includes a second pair of opposing, vertically-oriented rails 25, 26 and a second pair of opposing, horizontally-oriented rails 27, 28, which collectively define an interior structure located within the perimeter of the frame 20. As best shown in FIG. 2, the primary structure of the frame 20 is established by virtue of: (i) each of the vertically-oriented rails 21, 22 of the first set of rails 21, 22, 23, 24 being interlocked with each of the horizontally-oriented rails 27, 28 of the second set of rails 25, 26, 27, 28; (ii) each of the horizontally-oriented rails 23, 24 of the first set of rails 21, 22, 23, 24 being interlocked with each of the vertically-oriented rails 25, 26 of the second set of rails 25, 26, 27, 28; and (iii) each of the vertically-oriented rails 25, 26 of the second set of rails 25, 26, 27, 28 being interlocked with each of the horizontally-oriented rails 27, 28 of the second set of rails 25, 26, 27, 28. In this exemplary embodiment, the vertically-oriented rails 21, 22 of the first set of rails 21, 22, 23, 24 and the vertically-oriented rails 25, 26 of the second set of rails 25, 26, 27, 28 are of a greater length than the horizontally-oriented rails 23, 24 of the first set of rails 21, 22, 23, 24 and the horizontally-oriented rails 27, 28 of the second set of rails 25, 26, 27, 28. As such, the frame 20 in this exemplary embodiment has a substantially rectangular shape.

Although the frame 20 is primarily described herein and illustrated within the drawings as including a total of eight rails and retaining a substantially rectangular shape, it should be appreciated that the frame 20 is not necessarily limited to such a construction. Rather, the total number of rails in the frame 20, the allocation of rails between the first set of rails largely defining the perimeter of the frame 20 and the second set of rails defining the interior structure of the frame 20, and the length of the respective rails may vary to accommodate mattresses of different sizes, shapes, and/or weights, without departing from the spirit and scope of the present invention. For instance, alternative embodiments in which the second set of rails 25, 26, 27, 28 defining the interior structure of the frame 20 include more than four rails, as well as embodiments in which the second set of rails defining the interior structure of the frame 20 include fewer than four rails, are contemplated by the present invention. Further, alternative embodiments in which the length of the rails of the frame 20 is such that the frame 20 retains a non-rectangular shape (e.g., a square) are also contemplated. As the benefits and advantages derived from the rails of the frame 20 being constructed of an expanded thermoplastic foam will still be realized in such alternative embodiments, one of skill in the art will readily appreciate that such modifications can be made without departing from the spirit and scope of the present invention.

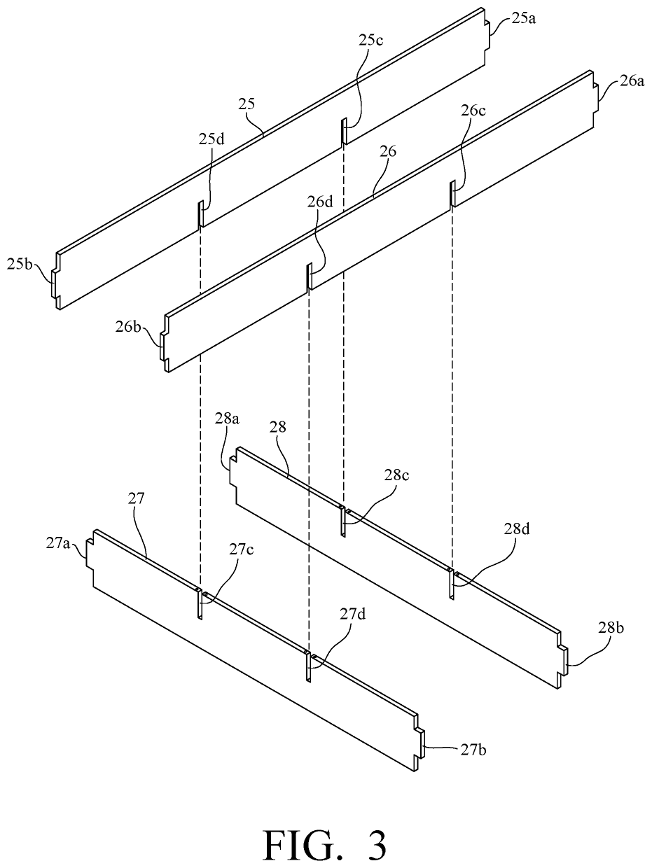

Referring now specifically to FIGS. 2 and 3, in this exemplary embodiment, the second set of rails 25, 26, 27, 28 defining the interior structure of the frame 20 are interlocked with the first set of rails 21, 22, 23, 24 via mortise and tenon type joints. In this regard, each end of each horizontally-oriented rail 27, 28 of the second set of rails 25, 26, 27, 28 defines a tenon 27a, 27b, 28a, 28b (i.e., a male member) which can be press fit into a corresponding opening 22a, 22b defined by a vertically-oriented rail 21, 22 of the first set of rails 21, 22, 23, 24. Accordingly, in this exemplary embodiment, the horizontally-oriented rails 27, 28 of the second set of rails 25, 26, 27, 28 define a total of four tenons, and the vertically-oriented rails 21, 22 of the first set of rails 21, 22, 23, 24 define a total of four openings 22a, 22b, two of which are shown in FIG. 2. Similarly, each end of each vertically oriented rail 25, 26 of the second set of rails 25, 26, 27, 28 defines a tenon 25a, 25b, 26a, 26b which can be press fit into a corresponding opening 24a, 24b defined by one of the horizontally-oriented rails 23, 24 of the first set of rails 21, 22, 23, 24. Accordingly, in this exemplary embodiment, the vertically-oriented rails 25, 26 of the second set of rails 25, 26, 27, 28 define a total of four tenons, and the horizontally-oriented rails 23, 24 of the first set of rails 21, 22, 23, 24 define a total of four openings 24a, 24b, two of which are shown in FIG. 2. It is, of course, contemplated, however, that a number of other configurations or geometries may also be utilized, including extruded I-Beam shaped rails and the like, and can be used to construct an exemplary bed foundation without departing from the spirit and scope of the present invention.

Referring still to FIGS. 2 and 3, in addition to being interlocked with the first set of rails 21, 22, 23, 24, the respective rails of the second set of rails 25, 26, 27, 28 are also interlocked with each other. To this end, and in this exemplary embodiment, the vertically-oriented rails 25, 26 of the second set of rails 25, 26, 27, 28 each define two notches. The vertically-oriented rails 25, 26 each define a first notch 25c, 26c that corresponds to one of two notches 28c, 28d defined by one of the horizontally-oriented rails 28 of the second set of rails 25, 26, 27, 28. The vertically-oriented rails 25, 26 then each further define a second notch 25d, 26d that corresponds to one of two notches 27c, 27d defined by the other horizontally-oriented rail 27 of the second set of rails 25, 26, 27, 28. The second set of rails 25, 26, 27, 28 can thus be interlocked with each other by aligning the notches 25c, 25d, 26c, 26d defined by the vertically-oriented rails 25, 26 with the corresponding notches 27c, 27d, 28c, 28d defined by the horizontally-oriented rails 27, 28 and press fitting the vertically-oriented rails 25, 26 and the horizontally-oriented rails 27, 28 together.

Referring now again to FIGS. 1-3, as noted above, the overall weight of the frame 20, and thus the foundation 10 as a whole, is reduced by virtue of each rail 21, 22, 23, 24, 25, 26, 27, 28 being constructed of a thermoplastic foam. Suitable expanded thermoplastic foams which can be utilized in the construction of the rails 21, 22, 23, 24, 25, 26, 27, 28 of the frame 20 include polypropylene (PP) foam, polyethylene (PE) foam, and other types of structural foam such as polyethylene terephthalate (PET) foams, polyiso (thermoset) foams, polyvinyl chloride (PVC) foams, and fiberglass-reinforced polyurethane (PU) foam, which are 100% recyclable, waterproof, and substantially lighter than the wooden or other weighted materials traditionally used for the construction of bed foundations. In this exemplary embodiment, the rails 21, 22, 23, 24, 25, 26, 27, 28 of the frame 20 are comprised of a polyethylene foam. However, regardless of which type of expanded thermoplastic foam is utilized, the reduced weight of the plurality of rails 21, 22, 23, 24, 25, 26, 27, 28 serves to not only reduce costs associated with shipping, but to also enable individuals to more easily lift and carry the foundation 10 without sacrificing the structural integrity of the foundation 10.

Referring again to FIGS. 2 and 3, each rail 21, 22, 23, 24, 25, 26, 27, 28 of the frame 20 may be initially formed via an extrusion process in which thermoplastic material, such as polypropylene or polyethylene, is melted, mixed with a foaming agent, such as a halogenated hydrocarbon, and then extruded through a die. Of course, the initial formation of each rail 21, 22, 23, 24, 25, 26, 27, 28 may also be achieved using alternative manufacturing techniques without departing from the spirit and scope of the present invention. For instance, in some embodiments, the rails 21, 22, 23, 24, 25, 26, 27, 28 may be initially formed using alternative manufacturing processes, such as injection molding. Once initially formed, the openings 22a, 22b, 24a, 24b for receiving the tenons 25a, 25b, 26a, 26b, 27a, 27b, 28a, 28b of the second set of rails 25, 26, 27, 28 can then be made in the first set of rails 21, 22, 23, 24 by removing portions of the mid-section of the first set of rails 21, 22, 23, 24. Likewise, once the second set of rails 25, 26, 27, 28 are initially formed, the tenons 25a, 25b, 26a, 26b, 27a, 27b, 28a, 28b and notches 25c, 25d, 26c, 26d, 27c, 27d, 28c, 28d can be made in the second set of rails 25, 26, 27, 28 by removing portions of the ends and mid-section of the second set of rails 25, 26, 27, 28.

Referring now specifically to FIG. 2, each notch defined by the second set of rails 25, 26, 27, 28 preferably extends approximately 50% of the height of the rail in which it is defined. When the second set of rails 25, 26, 27, 28 are interlocked with each other in the manner described above and with such notch construction, the top of each rail of the second set of rails 25, 26, 27, 28 resides along a common plane (i.e., the top of each rail of the second set of rails 25, 26, 27, 28 is coplanar) to provide a uniform, flat surface upon which the one or more panels 42, 44, 46 can be positioned to support a mattress. In this exemplary embodiment, the tops of the first set of rails 21, 22, 23, 24 also reside along the same plane as the tops of the second set of rails 25, 26, 27, 28 so that the flat surface provided by the interior structure of the frame 20 is extended to the perimeter of the frame 20. In this regard, the positioning of the tenons 25a, 25b, 26a, 26b, 27a, 27b, 28a, 28b of the second set of rails 25, 26, 27, 28 and corresponding openings 22a, 22b, 24a, 24b of the first set of rails 21, 22, 23, 24 in this exemplary embodiment are such that, when the first set of rails 21, 22, 23, 24 are interlocked with the second set of rails 25, 26, 27, 28 in the manner described above, the tops of the first set of rails 21, 22, 23, 24 and the tops of the second set of rails 25, 26, 27, 28 reside along a common plane. Alternative frame 20 constructions are, however, contemplated in which the tops of the first set of rails 21, 22, 23, 24 and the tops of the second set of rails 25, 26, 27, 28 do not reside along a common plane. For instance, in some alternative embodiments the tops of the first set of rails 21, 22, 23, 24 may reside on a plane which, when the frame 20 is assembled, is higher than the plane on which the tops of the second set of rails 25, 26, 27, 28 reside so that the interior structure of the frame 20 is recessed relative to the perimeter of the frame 20.

Referring again to FIGS. 2 and 3, in this exemplary embodiment, the plurality of openings 60 are also made into the tops of the rails on which the one or more panels 42, 44, 46 are positioned, which, in this case, is each rail within both the first set of rails 21, 22, 23, 24 and the second set of rails 25, 26, 27, 28. The importance of such openings 60 is further described below.

The openings 22a, 22b, 24a, 24b of the first set of rails 21, 22, 23, 24, the tenons 25a, 25b, 26a, 26b, 27a, 27b, 28a, 28b and notches 25c, 25d, 26c, 26d, 27c, 27d, 28c, 28d of the second set of rails 25, 26, 27, 28, and the openings 60 of both the first set of rails 21, 22, 23, 24 and the second set of rails 25, 26, 27, 28 can be made using known subtractive manufacturing techniques. Subtractive manufacturing techniques suitable for such application include, but are not necessarily limited to, drilling, die cutting, water jet cutting, CNC milling, and the like. In instances where the first set of rails 21, 22, 23, 24 and the second set of rails 25, 26, 27, 28 are formed via injection molding, the mold(s) utilized may include features which impart the openings 22a, 22b, 24a, 24b of the first set of rails 21, 22, 23, 24, the tenons 25a, 25b, 26a, 26b, 27a, 27b, 28a, 28b of the second set of rails 25, 26, 27, 28, the notches 25c, 25d, 26c, 26d, 27c, 27d, 28c, 28d of the second set of rails 25, 26, 27, 28, and/or the openings 60 of both the first set of rails 21, 22, 23, 24 and the second set of rails 25, 26, 27, 28 at the time of initial rail formation.

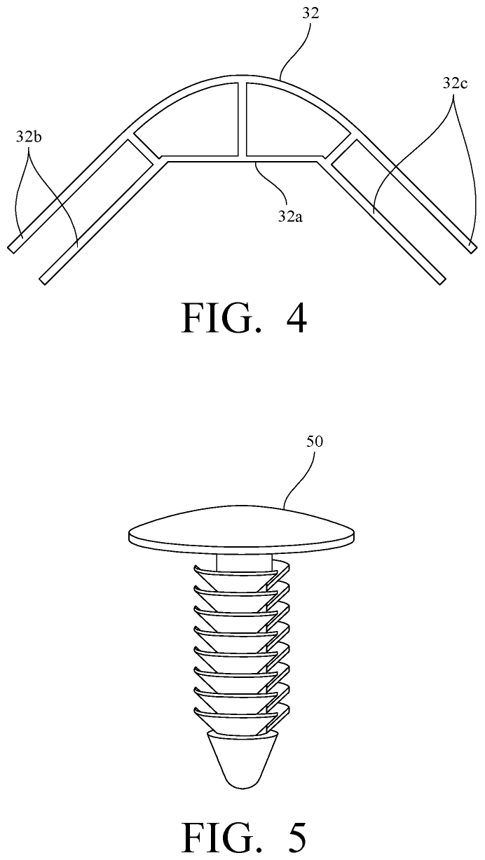

Referring now to FIGS. 1, 2, and 4, in this exemplary embodiment, the frame 20 further includes a plurality of brackets 32, 34, 36, 38, which interconnect the first set of rails 21, 22, 23, 24 and define the corners, and thus partially define the perimeter of the frame 20. In this regard, the brackets 32, 34, 36, 38 can also be characterized as “corner brackets.” As best shown in FIG. 2, each bracket 32, 34, 36, 38 is configured to interconnect two rails from the first set of rails 21, 22, 23, 24 together. To this end, and in this exemplary embodiment, each bracket 32, 34, 36, 38 defines, and thus can be characterized as including: a central body 32a, 34a, 36a, 38a; a first pair of flanges 32b, 34b, 36b, 38b extending from the central body 32a, 34a, 36a, 38a; and a second pair flanges 32c, 34c, 36c, 38c extending from the central body 32a, 34a, 36a, 38a, as best shown in FIG. 4. The first pair of flanges 32b, 34b, 36b, 38b of each respective bracket 32, 34, 36, 38 include an inner flange and an outer flange. The inner flange and the outer flange are spaced apart from each other so as to define a slot into which an end of one of the rails of the first set of rails 21, 22, 23, 24 can be press fit. The second pair of flanges 32c, 34c, 36c, 38c of each respective bracket 32, 34, 36, 38 similarly includes an inner flange and outer flange spaced apart from each other as to define a slot into which another rail of the first set of rails 21, 22, 23, 24 can be press fit. As best shown in FIG. 2, the height of brackets 32, 34, 36, 38 corresponds to the height of the first set of rails 21, 22, 23, 24.

Referring still to FIGS. 1, 2, and 3, to aid in minimizing the weight of the brackets 32, 34, 36, 38, and thus the overall weight of the frame 20, in this exemplary embodiment, the central body 32a, 34a, 36a, 38a of each respective bracket 32, 34, 36, 38 is substantially hollow. To further aid in minimizing the weight of the frame 20, like the rails 21, 22, 23, 24, 25, 26, 27, 28, each bracket 32, 34, 36, 38 is preferably constructed, at least in part, of a thermoplastic material. Suitable thermoplastic materials which may be utilized in the construction of the brackets 32, 34,36, 38 include polypropylene, polyethylene, or another type of thermoplastic such as polyethylene terephthalate, polyiso (thermoset) plastics, polyvinyl chloride, and polyurethane, which is substantially lighter than the wooden or other weighted materials traditionally used for the construction of bed foundations. In this exemplary embodiment, each bracket 32, 34, 36, 38 is comprised of a polyethylene thermoplastic material. Accordingly, in this exemplary embodiment, each of the respective components of the frame 20 is comprised, in full or in part, of a thermoplastic material. In some instances, the thermoplastics utilized in the construction of the respective components of the frame 20 can be infused with various fibers to provide such components with added strength and durability.

Referring still to FIGS. 1, 2, and 4, similar to the rails 21, 22, 23, 24 of the frame 20, the brackets 32, 34, 36, 38 in this exemplary embodiment are also formed by an extrusion process in which a thermoplastic material is melted and subsequently extruded through as a die. Accordingly, the die (or dies) from which the brackets 32, 34, 36, 38 are extruded, is such that, when formed, each bracket 32, 34, 36, 38 exhibits the features described above. As such, in this exemplary embodiment, the central body 32a, 32b, 32c, 32d, the first pair of flanges 32b, 34b, 36b, 38b, and the second pair of flanges 32c, 34c, 36c, 38c are integrally formed. Of course, the brackets 32, 34, 36, 38 may also be formed via different manufacturing processes without departing from the spirit and scope of the present invention. For instance, in alternative embodiments, the brackets 32, 34, 36, 38 may be formed using different additive manufacturing techniques, such as injection molding and/or 3D printing. Furthermore, it should also be appreciated that, in alternative embodiments, brackets of alternative construction and/or which include different features than the exemplary brackets 32, 34, 36, 38 described above and illustrated within the drawings, but are still suitable for interconnecting the first set of rails 21, 22, 23, 24 together, may alternatively be used. Indeed, while the use of brackets is generally preferred in the construction of the frame 20 for added stability, alternative embodiments in which the frame 20 is exclusively defined by the first set of rails 21, 22, 23, 24 and the second set of rails 25, 26, 27, 28 are also contemplated herein.

Referring now specifically to FIG. 1, in this exemplary embodiment, the foundation 10 includes a total of three panels: a first panel 42, which defines the left portion of the upper surface of the foundation 10; a second panel 44, which defines the central portion of the upper surface of the foundation 10; and a third panel 46, which defines the right portion of the upper surface of the foundation 10. As shown in this exemplary embodiment, the dimensions of the first panel 42, the second panel 44, and the third panel 46 are such that, when placed on the frame, the first panel 42, the second panel 44, and the third panel 46 collectively cover the tops of each of the first set of rails 21, 22, 23, 24, the second set of rails 25, 26, 27, 28, and the brackets 32, 34, 36, 38. Of course, in alternative embodiments, in which the top surface of the interior structure of the frame 20 and the top surface of the perimeter of the frame 20 do not reside along a common plane, the dimensions of the first panel 42, the second panel 44, and the third panel 46 can be modified as to collectively only cover the tops of the second set of rails 25, 26, 27, 28. Of course, it is further contemplated that while the use of multiple panels to define the surface of the foundation 10 upon which a mattress can rest may be advantageous in terms of reducing the spatial dimensions required to ship or otherwise transport the foundation, when disassembled, the use of multiple panels or a set number of multiple panels is not always required. Rather, the number of panels utilized can vary without departing from the spirit and scope of the present invention. Accordingly, alternative embodiments in which fewer than three panels (e.g., a single panel) are utilized to define a top surface of the foundation 10 for supporting a mattress, as well as embodiments in which more than three panels are utilized to define a top surface of the foundation 10 for supporting a mattress, are also contemplated.

Referring still to FIG. 1, like the rails 21, 22, 23, 24, 25, 26, 27, 28 of the frame 20, in this exemplary embodiment, each panel 42, 44, 46 is also constructed of an expanded thermoplastic foam, thus further reducing the weight of the foundation 10 as compared to traditional foundations primarily constructed of wooden or other similarly- or heavier-weighted materials. Suitable expanded thermoplastic foams which can be utilized in the construction of the panels 42, 44, 46 of the frame 20 include polypropylene (PP) foam, polyethylene (PE) foam, and other types of structural foam such as polyethylene terephthalate (PET) foams, polyiso (thermoset) foams, polyvinyl chloride (PVC) foams, and fiberglass-reinforced polyurethane (PU) foam, which are 100% recyclable, waterproof, and substantially lighter than the wooden or other weighted materials traditionally used for the construction of bed foundations. In this exemplary embodiment, each panel 42, 44, 46 is comprised of a polyethylene foam. However, regardless of which type of thermoplastic foam is utilized, the reduced weight of the panels 42, 44, 46 as compared to other weighted materials, such as wood, again serves not only to reduce costs associated with shipping, but to also enable individuals to more easily lift and carry the foundation 10 without sacrificing the structural integrity of the foundation 10.

Referring still to FIG. 1, like the rails 21, 22, 23, 24, 25, 26, 27, 28 of the frame 20, each respective panel 42, 44, 46 may be initially formed via an extrusion process in which thermoplastic material, such as polypropylene or polyethylene is melted, mixed with a foaming agent, such as a halogenated hydrocarbon, and then extruded through a die. Of course, the initial formation of each panel 42, 44, 46 may also be achieved using alternative manufacturing techniques without departing from the spirit and scope of the present invention. For instance, in some embodiments, each panel 42, 44, 46 may be initially formed using alternative manufacturing processes, such as injection molding. In this exemplary embodiment, subsequent to initial formation, a plurality of openings (not shown) are created in each respective panel 42, 44, 46 as to correspond to the openings 60 within the tops of the first set of rails 21, 22, 23, 24 and the second set of rails 25, 26, 27, 28. Although not shown within the drawings, the presence of such openings can be readily discerned by the positioning of the fasteners 50 in FIG. 1. The openings of the panels 42, 44, 46 can be implemented using known subtractive manufacturing techniques, such as drilling. In instances where the panels 42, 44, 46 are formed via injection molding, such openings may be imparted during the initial formation of the panels 42, 44, 46. In instances where the panels 42, 44, 46 as initially formed do not match the contours of the frame 20 (e.g., those portions of the frame 20 corresponding to the brackets 32, 34, 36, 38), some or all of the panels can optionally be cut to correspond to such contours using known subtractive manufacturing techniques (e.g., water jet cutting, CNC milling, sawing, and the like).

Referring now to FIGS. 1 and 5, to prevent the panels 42, 44, 46 from disassociating from, or moving relative to, the frame 20 while in use, while still facilitating ready disassembly and subsequent reassembly of the foundation 10, in this exemplary embodiment, each panel 42, 44, 46 is removably secured to the frame 20 by a plurality of fasteners 50. To further enable ready assembly and disassembly of the foundation 10 as needed, as well as subsequent recycling of each component of the foundation 10, each fastener 50 is preferably a press fastener (also sometimes referred to as a “push fastener” or “plastic rivet”) comprised of a recyclable plastic (e.g., nylon), such as that shown in FIG. 5, which can be installed by hand simply by pushing the fastener 50 through one of openings within the panels 42, 44, 46 and into an opening 60 within the frame 20.

A variety of press fasteners are known within the art and may be utilized to secure the panels 42, 44, 46 to the frame 20. As such, it should be appreciated that fasteners which may be utilized in the present invention are not limited to the construction shown in FIG. 5. It should also be appreciated that, while the use of press fasteners is generally preferred, other fasteners that are configured to removably secure the panels 42, 44, 46 to the frame 20 without the use of tools (e.g., snap fasteners, hook and loop fasteners, etc.) may alternatively be used without departing from the spirit and scope of the present invention. Furthermore, as the ease of shipping, lifting, and carrying the foundation 10 is attributable primarily to the lightweight construction of the frame 20 and, at least in some embodiments, the panels 42, 44, 46, it should also be appreciated that alternative embodiments in which fasteners which do require the use of tools (e.g., screws) for installation are also contemplated herein and that such embodiments still improve upon and provide certain advantages over traditional bedding foundations constructed of wood or other weighted materials. Additionally, while securing the panels 42, 44, 46 to the frame 20 may prove advantageous to prevent the panels 42, 44, 46 from disassociating from, or moving relative to, the frame 20, in some implementations, the panels 42, 44, 46 may be placed on top of the frame 20 without being secured thereto and still provide a surface sufficient to support a mattress. Accordingly, alternative embodiments in which the assembled foundation 10 does not include fasteners 50 and the panels 42, 44, 46 and the rails 21, 22, 23, 24, 25, 26, 27, 28 do not include corresponding openings for fasteners 50 are also contemplated herein.

Embodiments in which the plurality of rails 21, 22, 23, 24, 25, 26, 27, 28 and/or panels 42, 44, 46 are constructed entirely of a thermoplastic foam, as well as embodiments in which the plurality of rails 21, 22, 23, 24, 25, 26, 27, 28 and/or panels 42, 44, 46 are constructed in part of a thermoplastic foam (e.g., in conjunction with fibers or other structural additives for additional strength or durability) are contemplated herein. Similarly, embodiments in which the brackets 32, 34, 36, 38 are constructed entirely of a thermoplastic material as well as embodiments in which the brackets are constructed in part of a thermoplastic material (e.g., in conjunction with fibers or other structural additives for additional strength or durability) are also contemplated herein.

The exemplary foundation 10 described above is configured to accommodate a queen-size mattress. It should be appreciated, however, that the number and/or dimensions of the rails, notches defined in the rails, and/or number or dimensions of the panels of the foundation 10 may be modified in order to accommodate mattresses of different sizes. For example, to accommodate king-size mattresses, the number and/or dimensions of the rails and panels may be increased from that described above and illustrated within the drawings.

A preliminary weight comparison between the foundation 10 described above and a bed foundation constructed primarily of wood and currently available for purchase was performed to assess the extent to which the exemplary foundation 10 improves upon the strains or burdens associated with shipping, lifting, and carrying bed foundations currently commercially available. As previously indicated above, in the exemplary foundation 10: the first set of rails 21, 22, 23, 24, the second set of rails 25, 26, 27, 28, and the panels 42, 44, 46 are each constructed of an extruded polyethylene foam; the brackets 32, 34, 36, 38 were each constructed of extruded polyethylene; and the fasteners 32 securing the panels 42, 44, 46 to the frame 20 were comprised of nylon. The weight comparison revealed that the exemplary bed foundation made in accordance with the present invention was only twenty-nine pounds (29 lbs.) and approximately one-third (⅓) of the weight of a similar sized wooden bed foundation that was currently available for purchase. Of course, one of skill in the art will appreciate that while, in the exemplary foundation 10, both panels 42, 44, 46 and the respective components of the frame 20 are constructed of thermoplastic materials, alternative embodiments in which only one of the frame 20 or the panels 42, 44, 46 is constructed of a thermoplastic material and/or embodiments in which only some of the components of the frame 20 and/or some of the panels 42, 44, 46 are constructed of a thermoplastic material are possible and such embodiments would still provide a reduced weight advantage over similarly constructed foundations constructed of wood or other similarly- or heavier-weighted materials. For instance, in one alternative embodiment, each panel 42, 44, 46 of the foundation 10 may be constructed of fiberboard while each respective component of the frame 20 is constructed of a thermoplastic foam.

In one exemplary implementation, the foundation 10 is assembled by first assembling the frame 20 and then securing the panels 42, 44, 46 to the top of the frame 20 using the plurality of fasteners 50. To assemble the frame 20, the second set of rails 25, 26, 27, 28 are preferably first interlocked with each other to form the interior structure of the frame 20, which, in this case, initially retains the shape of an octothorpe. As noted above, the second set of rails 25, 26, 27, 28 are interlocked by aligning the notches 25c, 25d, 26c, 26d of the vertically oriented rails 25, 26 of the second set of rails 25, 26, 27, 28 with the corresponding notches 27c, 27d, 28c, 28d of the horizontally-oriented rails 27, 28 of the second set of rails 25, 26, 27, 28 and press fitting such rails together. Once the second set of rails 25, 26, 27, 28 are interlocked with each other, the first set of rails 21, 22, 23, 24 are then interlocked with the ends of the second set of rails 25, 26, 27, 28 by inserting the tenons 25a, 25b, 26a, 26b, 27a, 27b, 28a, 28b defined by the second set of rails 25, 26, 27, 28 into corresponding openings 22a, 22b, 24a, 24b defined by the first set of rails 21, 22, 23, 24 and press fitting the first set of rails 21, 22, 23, 24 and the second set of rails 25, 26, 27, 28 together, thus establishing the primary structure of the frame 20. Assembly of the frame 20 is then completed by inserting the ends of first set of rails 21, 22, 23, 24 into a slot of one of the brackets 32, 34, 36, 38 by press fitting the brackets 32, 34, 36, 38 and the first set of rails 21, 22, 23, 24 together. Once the frame 20 is assembled, the panels 42, 44, 46 are secured thereto by manually inserting the fasteners 32 through the corresponding openings 60 of the frame 20 and the panels 42, 44, 46 without the use of tools. In this exemplary embodiment and implementation, the frame 20 defines a three-by-three grid once fully assembled, as shown in FIG. 2. Of course, the shape of the assembled frame 20 may vary from that shown in FIG. 2 if modified to accommodate mattresses of different sizes.

Unless otherwise specified, or where context precludes, the method steps disclosed herein for assembly of the exemplary foundation 10 can be performed in any order. Additionally, one of skill in the art will appreciate that, in alternative embodiments where the brackets 32, 34, 36, 38 and/or the fasteners 50 are omitted from the foundation, that the assembly steps associated with the use of such components would similarly be omitted. Furthermore, while it is contemplated that the foundation embodiments described herein are entirely or substantially comprised of thermoplastic materials and can typically be assembled without the use of tools, it is further contemplated that certain aspects, features, or portions of the foundations can also be comprised of more traditional materials used in bed foundations, such as wood, cardboard, medium density fiberboard, and the like, and can be assembled using conventional tools and fastening methods (screws, glue, hook and loop, thermal welding, etc.) without departing from the spirit and scope of the present invention.

Although the foundation 10 is sometimes described herein in the context of being an assembled article, it is appreciated that the foundation 10 may be provided to consumers in an unassembled state for subsequent assembly, e.g., in accordance with the exemplary method of assembly described above. Accordingly, another aspect the present invention is directed to a kit for a bed foundation, which includes some or all of the components of a foundation consistent with that described above in an unassembled state. For instance, in some embodiments, the kit may include each of the respective components of the exemplary foundation 10 described above. In other embodiments, the kit may include only the rails 21, 22, 23, 24, 25, 26, 27, 28 of the frame 20 and the panels 42, 44, 46.

One of ordinary skill in the art will recognize that additional embodiments and implementations are also possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and may also be made without departing from the spirit or scope of the claimed invention.

What is claimed is:

1. A bed foundation, comprising:
a frame including a plurality of rails, the plurality of rails comprised of thermoplastic foam; and
one or more panels positioned on top of the frame to define an upper surface of the bed foundation for supporting a mattress.

2. The bed foundation of claim 1, wherein the plurality of rails includes
a first set of rails which at least partially define a perimeter of the frame, and
a second set of rails interlocked with the first set of rails, the second set of rails defining an interior structure within the perimeter of the frame, and each rail of the second set of rails being interlocked with at least one other rail of the second set of rails.

3. The bed foundation of claim 2, wherein each rail of the second set of rails defines a notch for receiving another rail of the second set of rails.

4. The bed foundation of claim 2, wherein each end of each rail of the second set of rails defines a tenon, and wherein each rail of the first set of rails defines one or more openings in which one of the tenons defined by the second set of rails is received.

5. The bed foundation of claim 1, wherein the frame further includes a plurality of brackets, with each bracket of the plurality of brackets interconnecting two rails of the first set of rails.

6. The bed foundation of claim 5, wherein each bracket of the plurality of brackets is comprised of a thermoplastic material.

7. The bed foundation of claim 5, wherein each bracket of the plurality of brackets defines a first slot in which one rail of the first set of rails is received and a second slot in which another rail of the first set of rails is received.

8. The bed foundation of claim 7, wherein each bracket of the plurality of brackets includes
a first pair of flanges defining the first slot of the bracket,
a second pair of flanges defining the second slot of the bracket, and
a central body from which the first pair of flanges and the second pair of flanges extend.

9. The bed foundation of claim 8, wherein the central body is substantially hollow.

10. The bed foundation of claim 1, wherein the one or more panels are comprised of thermoplastic foam.

11. The bed foundation of claim 10, wherein the plurality of rails of the frame are comprised of one of polypropylene (PP) foam, polyethylene (PE) foam, polyethylene terephthalate (PET) foam, polyisocyanurate (polyiso) foam, polyvinyl chloride (PVC) foam, and fiberglass-reinforced polyurethane (PU) foam, and
wherein the one or more panels are comprised of one of PP foam, PE foam, PET foam, polyiso foam, PVC foam, and fiberglass-reinforced PU foam.

12. The bed foundation of claim 1, wherein the one or more panels include multiple panels.

13. The bed foundation of claim 1, wherein the one or more panels are removably secured to the frame by a plurality of fasteners.

14. The bed foundation of claim 1, wherein the one or more panels are comprised of a medium density fiberboard.

15. A kit for a bed foundation, comprising
a plurality of rails configured to interlock with each other to at least partially define a frame of the bed foundation, the plurality of rails comprised of thermoplastic foam; and
one or more panels configured to be placed on top of the plurality of rails when the plurality of rails are interlocked, the one or more panels defining an upper surface of the bed foundation for supporting a mattress.

16. The kit of claim 15, wherein the plurality of rails includes a first set of rails and a second set of rails configured to interlock with each other, and wherein each rail of the second set of rails is configured to interlock with at least one other rail of the second set of rails to define an interior structure of the frame.

17. The kit of claim 16, wherein each rail of the second set of rails defines a notch for receiving another rail of the second set of rails.

18. The kit of claim 16, wherein each end of each rail of the second set of rails defines a tenon, and wherein each rail of the first set of rails defines one or more openings configured to receive one of the tenons defined by the second set of rails.

19. The kit of claim 16, further comprising a plurality of brackets, each bracket of the plurality of brackets configured to interconnect two rails of the first set of rails, and the plurality of brackets defining a portion of a perimeter of the frame.

20. The kit of claim 19, wherein each bracket of the plurality of brackets is comprised of a thermoplastic material.

21. The kit of claim 16, wherein the one or more panels are comprised of thermoplastic foam.

22. The kit of claim 21, wherein the plurality of rails are comprised of one of polypropylene (PP) foam, polyethylene (PE) foam, polyethylene terephthalate (PET) foam, polyisocyanurate (polyiso) foam, polyvinyl chloride (PVC) foam, and fiberglass-reinforced polyurethane (PU) foam, and
wherein the one or more panels are comprised of one of PP foam, PE foam, PET foam, polyiso foam, PVC foam, and fiberglass-reinforced PU foam.

23. The kit of claim 16, and further comprising a plurality of fasteners configured to removably secure the one or more panels to the frame.

24. The kit of claim 16, wherein the one or more panels are comprised of a medium density fiberboard.

25. A method of assembling a bed foundation, the method comprising:
interlocking a plurality of rails to at least partially define a frame of the bed foundation, the plurality of rails of the frame comprised of thermoplastic foam; and
positioning one or more panels on top of the frame to define an upper surface of the bed foundation for supporting a mattress.

26. The method of claim 25, wherein interlocking the plurality of rails comprises
interlocking a first set of rails of the plurality of rails with a second set of rails of the plurality of rails, the first set of rails at least partially defining the perimeter of the frame, and
interlocking a second set of rails of the plurality of rails together to define an interior structure within the perimeter of the frame.

27. The method of claim 26, wherein interlocking the first set of rails with the second set of rails and interlocking the second set of rails together is performed by press fitting the first set of the rails and the second set of rails together.

28. The method of claim 25, further comprising interconnecting the first set of rails together using a plurality of corner brackets, the first set of rails and the plurality of corner brackets defining the perimeter of the frame.

29. The method of claim 25, further comprising removably securing the one or more panels to the frame using a plurality of fasteners.
